(19) United States
(12) Patent Application Publication
(10) Pub. No.: US 2024/0318470 A1
(43) Pub. Date: Sep. 26, 2024

(54) HYBRID LOCKING SYSTEM FOR A SHOPPING CART

(71) Applicants: Wanzl GmbH & Co. KG, Leipheim (DE); Just Tec GmbH, Grünwald (DE)

(72) Inventors: Martin Schadhauser, München (DE); Dieter Stöckle, Landensberg (DE); Johann Daminger, Neu-Ulm (DE)

(21) Appl. No.: 18/579,760

(22) PCT Filed: Jul. 29, 2022
(86) PCT No.: PCT/EP2022/071387

§ 371 Date: Jan. 16, 2024

(30) Foreign Application Priority Data
Jul. 29, 2021 (DE) 10 2021 119 711.2

(51) Int. Cl. E05B 73/00; A47F 10/04; E05B 47/00

(52) U.S. Cl. CPC E05B 73/00; A47F 10/04; E05B 47/0012; E05B 2047/0017; E05B 2047/0024; E05B 2047/0095

(57) ABSTRACT

In an embodiment a locking device for a first transport carriage includes a gripping arm configured to lock a key of a second transport carriage, a slide, an electric motor and/or an actuator configured to drive an eccentric disc for initiating a release movement of the slide, a receiver configured to receive a Bluetooth, Near Field Communication or WLAN signal from a transmitter, wherein the receiver is configured to control the motor or the actuator via an electrical or electromagnetic signal, wherein the slide is configured to release the key based on the initiated release movement when the electric motor and/or the actuator receives the electrical or electromagnetic signal.

### CROSS-REFERENCE TO RELATED APPLICATIONS

This patent application is a national phase filing under section 371 of PCT/EP2022/071387, filed Jul. 29, 2022, which claims the priority of German patent application 102021119711.2, filed Jul. 29, 2021, each of which is incorporated herein by reference in its entirety.

### TECHNICAL FIELD

The present invention relates to a locking device which is fixed to a shopping cart, as a result of which in each case two shopping trolleys can be detachably connected to one another, a shopping cart with a locking device and a method for detachably connecting a transport carriage.

### BACKGROUND

It is known in the prior art to detachably connect the shopping trolleys of a supermarket by means of a coin deposit lock. In this way, it is possible to prevent, that individual shopping trolleys are brought out of the region of the supermarket and are thus no longer available to the customer of the supermarket. The coin deposit lock can be opened by a deposit, in particular a ₁-Euro piece, as a result of which a single shopping cart is available to the customer for his purchase. In documents US20070187208A1 and U.S. Pat. No. 5,421,445, coin deposit locks are described in which a lever action against spring forces is generated with a coin in order to trigger a pin/key of a shopping cart. The two documents US20190218830A1 and CH 87910A show double eccentric disks, the rotation of which is used by 90° to engage or disengage gripping arms from a taper or a constriction of a pin.

### SUMMARY

The coin deposit system has proven successful in order to prevent misuse of individual shopping trolleys. However, the customer does not always have the appropriate coin piece at any time. In these cases, the supermarket must provide an alternate possibility, as a result of which, for example, the cash workers can be impaired in their workflow.

Embodiments provide a device and a method for providing a further possibility for triggering a shopping cart from a concatenation of shopping trolleys and an alternative possibility is offered in order to release a shopping cart from an amount of shopping trolleys without the provision of a deposit.

As a first aspect of the invention, a hybrid locking device of a transport carriage is provided, in particular a shopping cart, for releasably connecting to a key of a further transport carriage, wherein the locking device is suitable for at least partially receiving the key, wherein the locking device releases a received key by the input of a coin and/or by an electrical or electromagnetic signal.

The device according to the invention opens up to the customer two possibilities of disconnecting a shopping cart from an amount of shopping carts, namely with a coin or with an electromagnetic signal, which is generated by a smartphone.

A second aspect of the invention provides a digital locking system of a transport carriage, in particular a shopping cart, for releasably connecting to a key of a further transport carriage, wherein the locking device is suitable for at least partially receiving the key, wherein the locking device releases a received key by an electrical or electromagnetic signal, wherein the locking device is comprising: a gripping arm for locking the key, an electric motor and/or an actuator for driving an eccentric disc for initiating a release movement of the slide, a receiving unit for communication with a transmitting unit, in particular a smartphone, via, for example, Bluetooth, Near Field Communication or WLAN, wherein the receiving unit controls the motor via the electrical or electromagnetic signal, wherein the release movement of the slide leads to release of the key.

As a third aspect of the invention, a shopping cart with a locking device is provided.

A fourth aspect of the invention provides a method for detachably connecting a first transport carriage, in particular a shopping cart, to a second transport carriage, wherein the first and second transport carriages comprise a locking device, comprising the steps of: unlocking a key from the locking device by a release movement of a slide, wherein the release movement is caused by an electric motor and/or an actuator or a coin inserted into the locking device.

According to a further exemplary embodiment of the invention, a locking device is provided, wherein the locking device comprises: a gripping arm for locking the key, a gripping arm for locking the coin, wherein the insertion of the coin into the locking device results in a release movement of a slide, an electric motor and/or an actuator for driving an eccentric disc for initiating a release movement of the slide, a receiving unit for communication with a transmitting unit, in particular a smartphone, via, for example, Bluetooth, Near Field Communication or WLAN, wherein the receiving unit controls the motor via the electrical or electromagnetic signal, wherein the release movement of the slide leads to the release of the key.

Advantageously, the locking device according to the invention has a slide which can initiated to release of an ejection element of the key in two ways. As a result, the key can be triggered with a deposit coin or an electromagnetic signal from the locking device.

In a still further embodiment according to the invention, a locking device is provided, wherein the slide interacts with an ejection element in such a way that a release movement of the slide leads to the release of the ejection element, whereby the ejection element releases a received key.

According to an exemplary embodiment of the invention, a locking device is provided, wherein a coin slide causes the slide to move to a release movement by the input of a coin.

In a further embodiment according to the invention, a locking device is provided, wherein the coin slide has a first inclined surface cooperating with a second inclined surface of the slide to generate a release movement.

According to an exemplary embodiment of the invention, a locking device is provided, wherein the inclined surface and the inclined surface each have an angle of 48°.

By a preferred angle of 48°, a problem-free sliding of the inclined surfaces is made possible.

By arranging inclined surfaces, a movement can be converted upwards into a lateral movement, so that the insertion of a deposit coin results in a lateral movement (release movement) of the slide.

According to a further exemplary embodiment of the present invention, a locking device is provided, wherein the ejection element is guided by the insertion of the key into the locking device into an interlocking with the slide and/or as a result of which ejection element is spring-biased and/or wherein the interlocking can be released by a release movement of the slide.

In a further embodiment according to the invention, a locking device is provided, wherein the ejection element has a stop surface on which a stop face of the gripping element rests on as long as the ejection element with the slide has an interlocking, so that the gripping arm locks the key and/or wherein the gripping arm is spring-biased.

As an idea of the invention, it can be considered to provide a locking device for a shopping cart which offers the possibility, in addition to the use of a coin deposit, to release a locked key from the locking device with a smartphone. For this purpose, the locking device contains a receiver, which, for example, can establish a connection to the smartphone of the customer via Bluetooth or WLAN. In addition, the locking device according to the invention has an electric motor, which controls the releasing of the shopping cart in question from the concatenated amount of shopping trolleys.

The individual features can of course also be combined with one another, as a result of which, in part, advantageous effects can also be set which go beyond the sum of the individual effects.

### BRIEF DESCRIPTION OF THE DRAWINGS

Further details and advantages of the invention will be apparent from the exemplary embodiments illustrated in the drawings.

FIG. 1 shows a push handle unit with a locking device which is actuated via a smartphone; alternatively, a key can be unlocked from the locking device by means of a coin;

FIG. 2 shows a shopping cart comprising the push handle unit;

FIG. 3 shows a locking device according to the invention, wherein a slide can be driven in two ways in order to release the key;

FIG. 4 shows the locking device in a perspective view with an electric motor and a coin slide for moving the slide;

FIG. 5 shows a key which is inserted into a locking device, wherein the key can be released by the input of the coin;

FIG. 6 shows a released key after the entry of the coin;

FIG. 7 shows an exploded view of the locking device according to the invention;

FIG. 8 shows a further schematic illustration of the locking device;

FIG. 9 shows a schematic illustration of an inventive embodiment with only one spring;

FIG. 10 shows the slide with the coin slide, wherein the inclined surfaces have a vertical section;

FIG. 11 shows a section of the coin slide with an inclined surface, which has a vertical section;

FIG. 12 shows a battery holder for supplying power to the locking system; and

FIG. 13 shows an enlargement of a part of the battery compartment with the contacts.

### DETAILED DESCRIPTION OF ILLUSTRATIVE EMBODIMENTS

FIG. 1 shows a push handle unit 21 of a shopping cart 22, on which a locking device 11 is arranged, by means of which, in the case of a respective arrangement of a locking device 11 on a shopping cart, detachable concatenation of shopping trolleys 22 can result. The locking device 11 can alternatively be used for a conventional coin deposit lock. A coin deposit lock releases the connection of a shopping cart to an amount of shopping trolleys if a deposit, in particular a ₁-Euro piece, is introduced into the deposit lock. According to the invention, the removal of the shopping cart from a concatenation is controlled by a transmission unit, in particular a smartphone, after the user of the smartphone has been authorized by the smartphone. The smartphone-controlled locking device according to the invention therefore makes it possible to dispense with a deposit. In particular, the locking device 11 is controlled via a smartphone 18, for example via a Bluetooth or a WLAN connection.

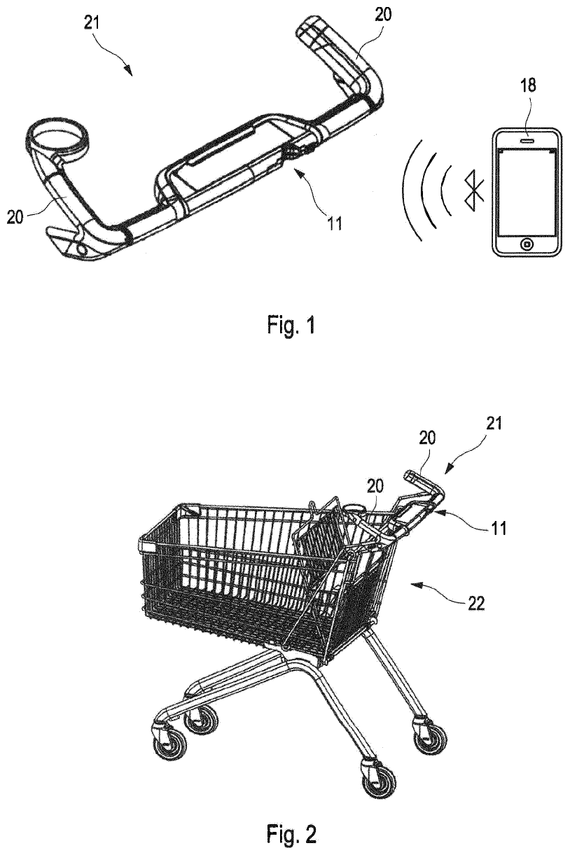

FIG. 2 shows a shopping cart 22, on the push handle unit 21 of which a locking device 11 is arranged, wherein a conventional coin deposit lock is replaced by a smartphone-controlled locking device according to the invention can be used. This makes it possible to retrofit a conventional shopping cart 22 with a deposit lock by means of a smartphone-controlled locking device 11. The smartphone-controlled locking device 11 according to the invention can be accommodated in the push handle unit 21 or in a promoter box, which is additionally arranged on the push handle unit 21. A promoter box serves in particular for the assessment of products or services.

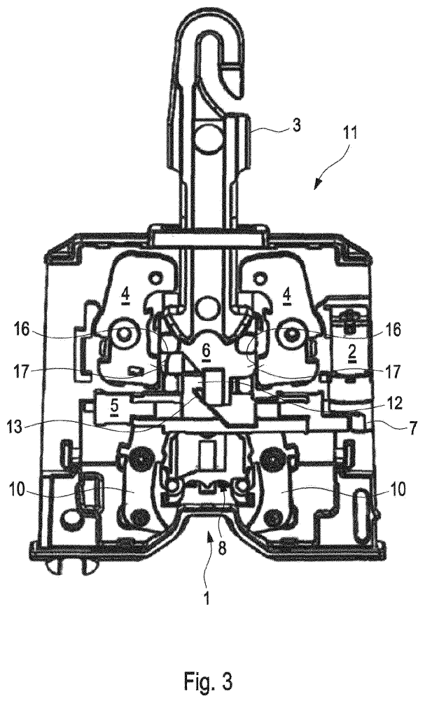

FIG. 3 shows a locking device 11 which can be arranged on a shopping cart. The locking device 11 is designed as a hybrid device, which means that, that the key 3 can be released in at least two variants. On the one hand, a coin can be inserted into the receiving opening 1, as a result of which the coin slide 8 presses upwards (with respect to the plane of the drawing) and interacts with the slide 5. In addition, the slide 5 can be driven by an electric motor 2 by means of an eccentric disk 7 or another preferred form/movement, whereby the key 3 is also ejected from the locking device 11. In addition, the two stop surfaces 16 and 17 are shown. In the retracted state of the ejection element 6, its stop surface 17 lies on the stop surface 16 of the gripping arm 4, as a result of which the gripping arms 4 remain closed. If the ejection element 6 is pressed upwards (with respect to the plane of the drawing) by the relaxing spring after being released by the slide 5, thus, the stop surfaces 16 of the gripping arms 4 no longer lie on the stop surfaces 17 of the ejection element 6 and the gripping arms 4, which are spring-biased, open and the key 3 is released.

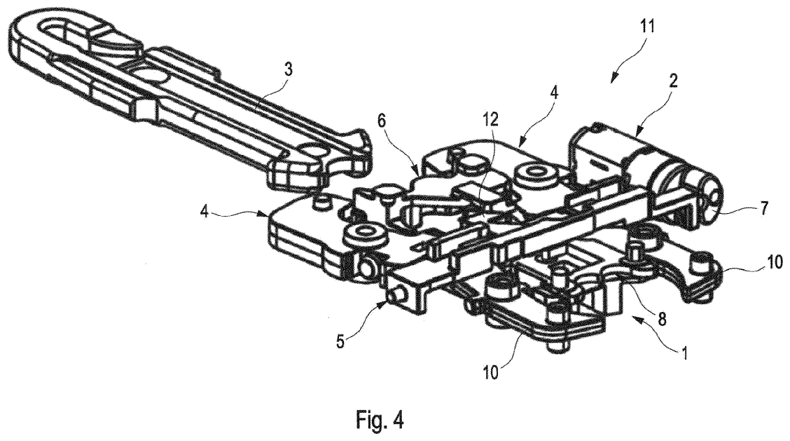

FIG. 4 shows the locking device 11 according to the invention in a perspective view, in which a key 3 can be inserted into the locking device 11. The inserted key 3 is held by the gripping arms 4. As a result of the insertion of the key 3, the ejection element 6 is pressed into the locking device 11, as a result of which a spring is compressed. The ejection element 6 is therefore spring-biased. In addition, a hook 13 of the ejection element 6 is gripped by a hook 12 of the slide 5, whereby the ejection element 6 is retained against the tension of the spring. The key 3 can be released in two ways. On the one hand, the slide 5 can be moved by the coin slide 8. By pressing a coin into the receiving opening 1, the coin slide 8 is pressed towards the key 3, wherein the gripping arms 4 are opened, as a result of which the key 3 is released and wherein the slide 5 is moved and as a result the ejection element 6 is released. In addition, an electromagnetic signal can be transmitted to the electric motor 2, for example by means of a smartphone, as a result of which the electric motor 2 drives an eccentric disk 7, which causes a displacement of the separator 5 in a manner, that the hook 12 of the slide 5 releases the hook 13 of the ejection element 6. After release of the hook 13, the spring of the ejection element 6 relaxes and pushes the ejection element 6 forwards, as a result of which the key is thrown out of the locking device 11. The electric motor 2 drives the eccentric disk 7 one or more, full revolutions, as a result of which the eccentric disk 7 is again in the starting position.

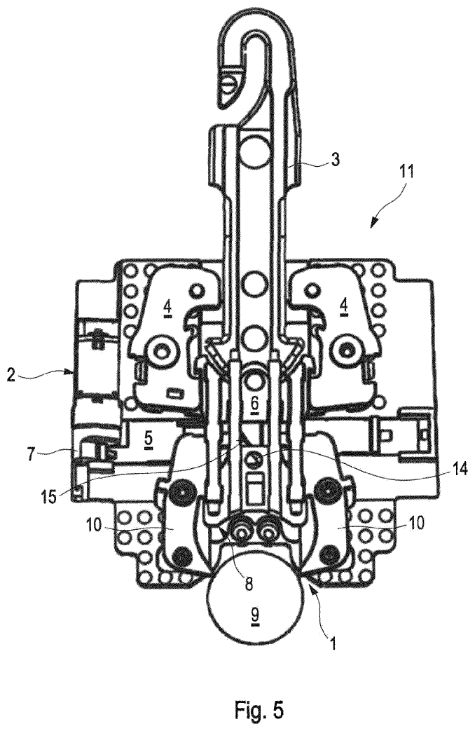

FIG. 5 shows a locking device 11 with a locked key 3. By inserting a coin 9 into the receiving opening 1, the coin slide 8 is pressed upwards (with respect to the plane of the drawing). As a result, the inclined surface 14 presses along the inclined surface 15 of the slide 5, as a result of which the slide 5 is displaced parallel to the right (with respect to the plane of the drawing) and releases the spring-biased ejection element 6. The ejection element 6 presses the key 3 out of the locking device 11. The gripping arms 10 hold the coin 9 in the locking device 11 and thereby lock the coin 9 within the locking device. The inclined surface 14 and the inclined surface 15 may in particular have a preferred angle of 48°.

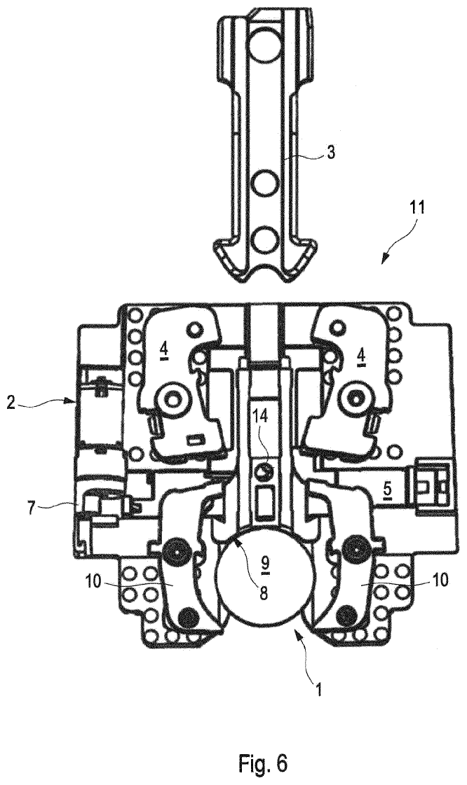

FIG. 6 shows a key 3 which has been ejected from the locking device 11 after the coin entry.

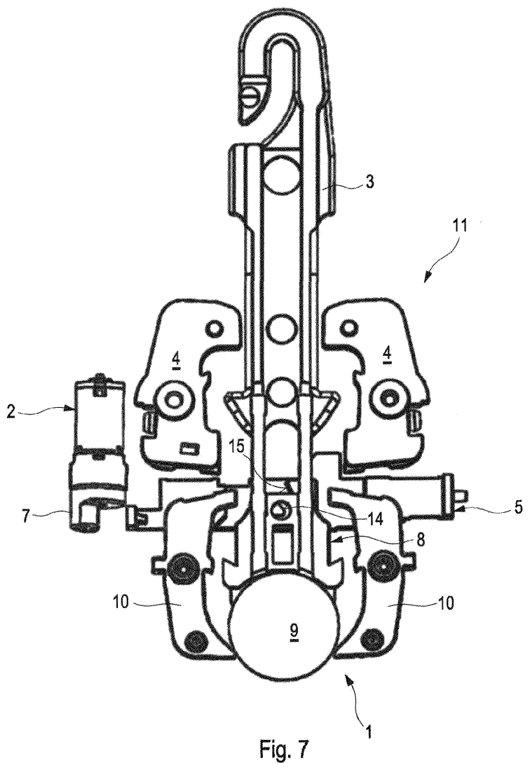

FIG. 7 shows the individual elements of the locking device in an exploded view. The key 3 with the coin slide 8 is shown with the inclined surface 14. The inclined surface 14 is complementary to the inclined surface 15 of the slide 5. In addition, the gripping arms 4 for gripping the key 3 and the gripping arms 10 for gripping and holding an inserted coin 9 are shown. The slide 5 can be moved horizontally (with respect to the plane of the drawing) in order to release the ejection element 6. A corresponding horizontal movement of the slide 5 can be effected by the eccentric disk 7 of the electric motor 2 and by the coin slides 8 are caused.

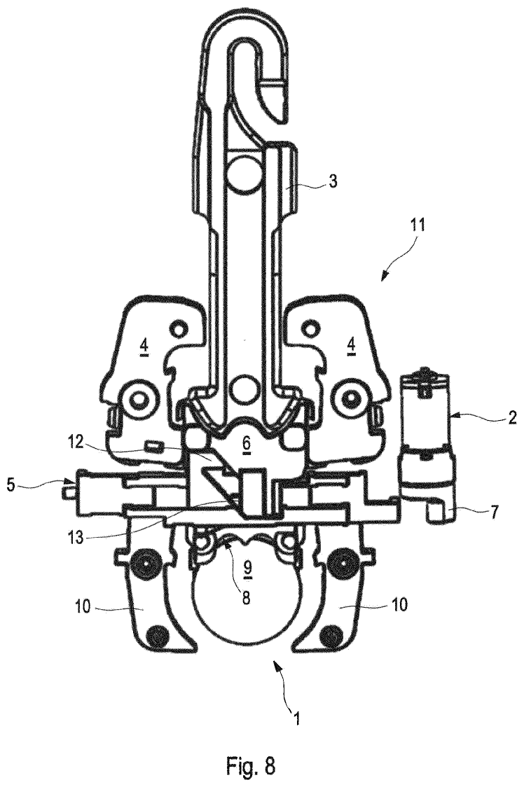

FIG. 8 shows a key 3 inserted into the locking device 11. By pressing the key 3, the hook 12 of the slide 5 can be hooked with the hook 13 of the ejection element and the key 3 is locked in the locking device 11. As a result, the gripping arms 10 open, as a result of which the coin 9 can be removed.

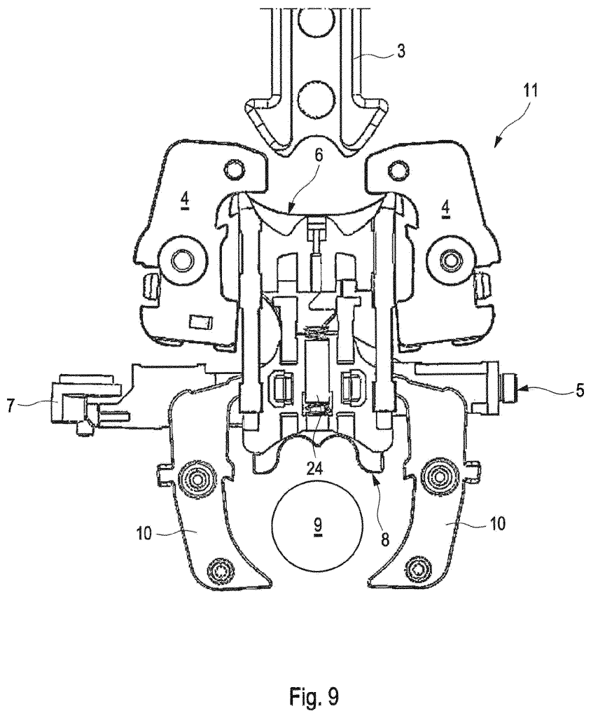

FIG. 9 shows a further embodiment of the invention with only one spring 24, which presses both the coin slide 8 downwards and the ejection element 6 upwards. In particular, the spring 24 is arranged in such a way that the ejection element 6 is not pressed together immediately when the key 3 is pressed in, but only in a last section of the insertion process of the key 3 into the locking device. This ensures that the ejection element 6 does not already exert an ejection force on the key 3 at an early stage of the entry of the key 3, so that there is only a very late and short range, in which there is both a spring force on an inserted coin 9 and on the key 3. This is intended to prevent a simultaneous release of both the key 3 and the coin 9 by manipulation on the locking system is made possible.

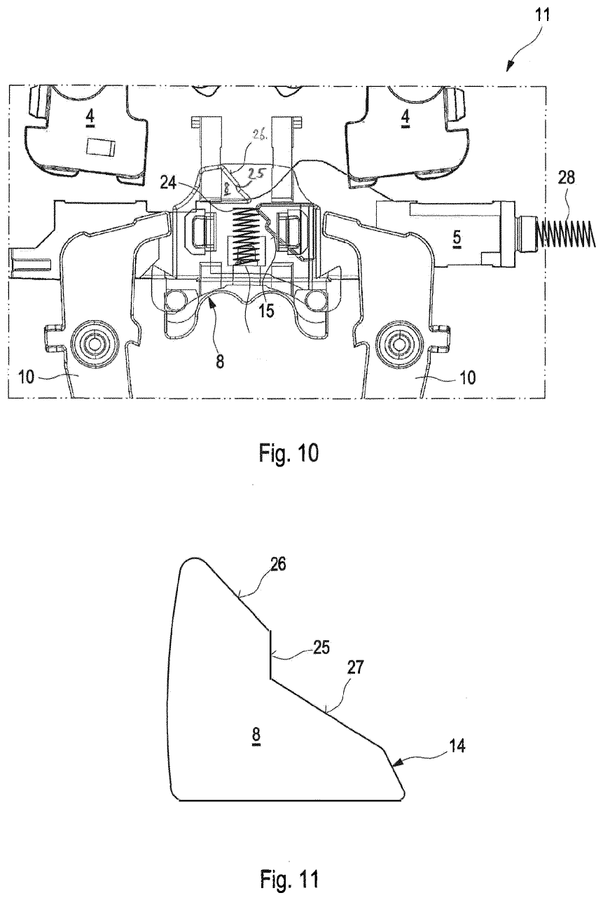

FIG. 10 shows a coin slide 8 with the inclined surface 14, which cooperates with the inclined surface 15 of the slide 5 in such a way that the slide 5 is displaced horizontally by a vertical movement of the coin slide 8. Vertical sections 25 can be provided in the inclined surfaces 14 and/or 15, by means of which vertical sections 25 a movement of the slide 6 despite vertical movement of the coin slide 8 is prevented. In this way, in particular, a state in which both the key 3 and the coin 9 are not completely held can be skipped, so to speak.

FIG. 11 shows a part of the coin slide 8 with the inclined surface 14, which has sections 26 and 27 which run obliquely, such that a vertical movement of the coin slide 8 into a horizontal movement of the slide 5 is transformed with these sections. In addition, a vertical section 25 is arranged, which also prevents a vertical movement of the slide 5 during a vertical movement of the coin slide 8.

In an alternative embodiment, the inclined surfaces 14 and/or 15 may have a high or a weak rising or falling slope, such that at a high slope a rapid movement of the coin slide 8 is transformed into a slow movement of the slide 5. In the case of a weak slope a slow movement of the coin slide 8 can be transformed into a rapid movement of the slide 5.

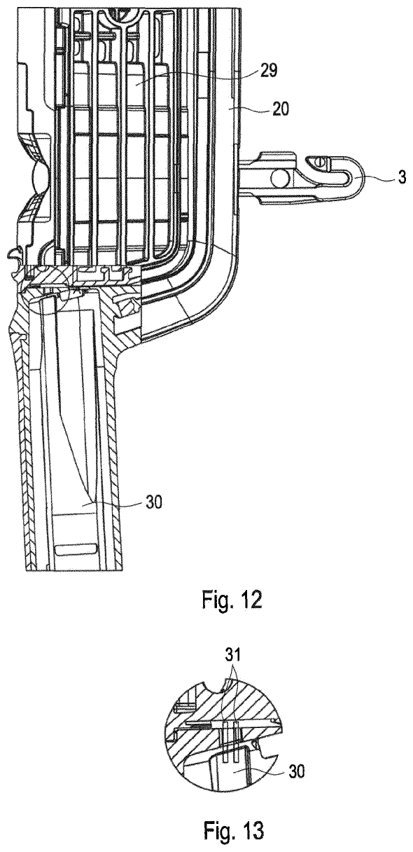

FIG. 12 shows the energy supply of the locking system which is ensured by a battery or an ACCU, wherein the battery is arranged in a holder in such a way that, that the locking system can be removed from the promoter box 29 without the battery having to be pulled out. The battery or batteries are arranged in particular in a battery compartment 30, wherein contacts 31 ensure that an energy supply to an electronic controller and one or more motors of the locking system it is ensured. The great advantage of the arrangement can be seen in that the electronics can be removed from the promoter box 29 and possibly repaired or replaced, without this, the battery or the batteries would have to be removed or at least moved. This simplifies a required repair.

FIG. 13 shows the battery compartment 30 and the contacts 31 which ensure an energy supply.

In a particular embodiment, an emergency release is provided, which is necessary in particular if the spring of the locking system is broken and a release of the key 3 is not possible as a result. In this way, it can be prevented that a single defective shopping cart can block a complete amount of shopping trolleys if its locking system is defective. In the case of emergency unlocking, individual recesses are provided, so that an unlocking can be performed without electric power.

A particular advantage of the hybrid locking system according to the invention for a shopping cart is that the locking system can supplement a conventional coin deposit lock. The customer can therefore select whether he wishes to release the key with a coin or with an electromagnetic signal, for example from his smartphone.

The locking device of a first shopping cart according to the invention can maintain communication with a smartphone, in particular can be caused by the smartphone, the locking device of the first shopping trolley is unlocked and ejected by a pin of a second shopping cart held in the locking device. The communication can take place by Bluetooth, in particular Bluetooth Low Energy (BLE) or Near Field Communication (NFC). In this way, a communication between the smartphone of a user and the locking device is contactless The invention also relates to a method for the production of. In near field communication (near field communication), data are transmitted contactlessly by means of RFID technology on the basis of an international transmission standard. For this purpose, loosely coupled coils are used which are connected by electromagnetic induction. Therefore, only a few centimeters communication is possible. The slider 5 is identical with the slide 5.

It should be noted that the term “comprising” does not exclude further elements or method steps, as is the term “one and” does not exclude a plurality of elements and steps.

The reference signs used serve merely to increase intelligibility and are in no way intended to be regarded as limiting, the scope of protection of the invention being represented by the claims.

1.-11. (canceled)

12. A hybrid locking device of a transport carriage for releasably connecting to a key of a further transport carriage, wherein the locking device is configured to at least partially receiving the key, wherein key is releasable from the locking device via coin input and/or via electrical or electromagnetic signal, the locking device is comprising:
a gripping arm configured to lock the key;
a gripping arm configured to lock the coin, wherein an insertion of the coin into the locking device results in a release movement of a slide;
an electric motor and/or an actuator configured to drive an eccentric disc for initiating a release movement of the slide; and
a receiver configured to communicate with a transmitter via Bluetooth, Near Field Communication or WLAN signals, wherein the receiver is configured to control the motor via electrical or electromagnetic signal,
wherein the release movement of the slide leads to a release of the key.

13. A locking device for a first transport carriage comprising:
a gripping arm configured to lock a key of a second transport carriage;
a slide;
an electric motor and/or an actuator configured to drive an eccentric disc for initiating a release movement of the slide; and
a receiver configured to receive a Bluetooth, Near Field Communication or WLAN signal from a transmitter, wherein the receiver is configured to control the motor or the actuator via an electrical or electromagnetic signal,
wherein the slide is configured to release the key based on the initiated release movement when the electric motor and/or the actuator receives the electrical or electromagnetic signal.

14. The locking device of claim 13, wherein the slide is configured to interact with an ejection element such that the ejection element ejects the key.

15. The locking device of claim 13, further comprising a coin slide, wherein the coin slide is configured to cause the slide to initiate the release movement via a coin input.

16. The locking device of claim 15, wherein the coin slide comprises a first inclined surface cooperating with a second inclined surface of the slide to initiate the release movement.

17. The locking device of claim 16, wherein each of the first inclined surface and the second inclined surface has an angle of 48°.

18. The locking device of claim 13, further comprising an ejection element, wherein the ejection element is configured to interlock with the slide and/or is spring biased when the key is inserted into the locking device, and/or wherein the ejection element is configured to release an interlock by the release movement of the slide.

19. The locking device of claim 18, wherein the ejection element comprises a stop surface on which a stop face (16) of the gripping arm is restable when the ejection element is interlocked with the slide so that the gripping arm locks the key and/or so that the gripping arm is spring-biased.

20. The first transport carriage comprising:
the locking device of claim 13,
wherein the first transport carriage and the second transport carriage are shopping carts.

21. A method for releasing the first transport carriage from the second transport carriage, wherein the first transport carriage comprises the locking device of claim 13, the method comprising:
unlocking the key from the locking device by the release movement of the slide,
wherein the release movement is caused by the electric motor and/or the actuator, or by a coin inserted into the locking device.

22. A method for releasing a first transport carriage from a second transport carriage, wherein the first transport carriage comprise a locking device including a gripping arm, a slide, an electric motor and/or an actuator and a receiver, the method comprising
receiving, by the receiver, a Bluetooth, Near Field Communication or WLAN signal from a transmitter,
controlling, by the receiver, the motor or the actuator via an electrical or electromagnetic signal in response to the received Bluetooth, Near Field Communication or WLAN signal;
driving, by the electric motor and/or the actuator, an eccentric disc;
initiating, by the eccentric disc, a release movement of the slide; and
releasing a key in response to the release movement.

23. The method of claim 22, wherein releasing the key comprises releasing the key by an ejection element, the ejection element releasing the key in response to the release movement of the slide.

24. The method of claim 22, further comprising:
inserting a coin in the locking device; and
initiating, by a coin slide, the release movement of the slide in response to inserting the coin.

25. The method of claim 24, wherein the coin slide comprises a first inclined surface cooperating with a second inclined surface of the slide to initiate the release movement.

26. The method of claim 25, wherein each of the first inclined surface and the second inclined surface has an angle of 48°.

27. The method of claim 22, further comprising:
interlocking an ejection element with the slide and/or biasing the ejection element with a spring when the key is inserted into the locking device, and/or
releasing the interlock in response to the release movement thereby ejecting the key.
